(19) United States
(12) Patent Application Publication
(10) Pub. No.: US 2026/0052224 A1
(43) Pub. Date: Feb. 19, 2026

(54) USING GENERATIVE MACHINE-LEARNING TO INTERPOLATE DROPPED FRAMES

(71) Applicant: Roku, Inc., San Jose, CA (US)

(72) Inventors: Thejaswi Raya, Fremont, CA (US); Sunil Ramesh, Saratoga, CA (US); Nishant Mendiratta, San Jose, CA (US); Neil Kraewinkels, San Jose, CA (US); Gordon Downie, Cambridgeshire (GB)

(21) Appl. No.: 18/802,695

(22) Filed: Aug. 13, 2024

(51) Int. Cl. H04N 7/01

(52) U.S. Cl. CPC H04N 7/0135

(57) ABSTRACT

Aspects of the disclosed technology provide solutions for improving video streams by generating dropped video frames. An example process can include steps for receiving a set of video frames, identifying a discontinuity in the set of frames, generating one or more replacement frames associated with the discontinuity, and providing the one or more replacement frames to a user. Systems and machine-readable media are also provided.

### BACKGROUND

### Field

This disclosure is generally directed to streaming media content, and more particularly, to the use of machine-learning techniques for improving video streams by generating dropped video frames.

### Summary

Provided herein are system, apparatus, article of manufacture, method and/or computer program product embodiments, and/or combinations and sub-combinations thereof, for generating media content.

In some aspects, a method is provided for generating missing media content, such as by generating dropped video frames to improve a user's media viewing experience. The method can be performed any of a variety of processor based device, including but not limited to a media device used to present or playback media content (e.g., using a display device is communicatively coupled to the media device), a server that is coupled to one or more media devices and/or media collection devices (e.g., cameras), and/or one or more IoT devices, such as security cameras.

The method can operate by receiving a set of video frames, identifying a discontinuity in the set of video frames, generating one or more replacement frames associated with the discontinuity based on at least one video frame selected from among the set of video frames, and providing the one or more replacement frames to a user.

In some aspects, a system is provided for generating dropped frames. The system can include one or more memories and at least one processor coupled to at least one of the one or more memories and configured to receive a set of video frames, identify a discontinuity in the set of video frames, generate one or more replacement frames associated with the discontinuity based on at least one video frame selected from among the set of video frames, and provide the one or more replacement frames to a user.

In some aspects, a non-transitory computer-readable medium is provided for customizing targeted media content. The non-transitory computer-readable medium can have instructions stored thereon that, when executed by at least one computing device, cause the at least one computing device to receive a set of video frames, identify a discontinuity in the set of video frames, generate one or more replacement frames associated with the discontinuity based on at least one video frame selected from among the set of video frames, and provide the one or more replacement frames to a user.

### BRIEF DESCRIPTION OF THE FIGURES

The accompanying drawings are incorporated herein and form a part of the specification.

FIG. 1 illustrates a block diagram of a multimedia environment, according to some examples of the present disclosure.

FIG. 2 illustrates a block diagram of a streaming media device, according to some examples of the present disclosure.

FIG. 3 is a diagram illustrating an example system environment that can be used to generate replacement frames, according to some examples of the present disclosure.

FIG. 4 is a diagram illustrating an example system that can be used to generate replacement frames, according to some examples of the present disclosure.

FIG. 5 is a diagram illustrating an example system that can be used to train a generative ML model for replacement frame generation, according to some examples of the present disclosure.

FIG. 6 is a diagram illustrating an example system that can be used to a train camera-specific ML models for replacement frame generation, according to some examples of the present disclosure.

FIG. 7 is a diagram illustrating steps of a process for generating replacement frames, according to some examples of the present disclosure.

FIG. 8 is a diagram illustrating an example of a neural network architecture, according to some examples of the present disclosure.

FIG. 9 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can generally access and consume videos using client devices such as, for example and without limitation, smart phones, set-top boxes, desktop computers, laptop computers, tablet computers, televisions (TVs), IPTV receivers, media devices, monitors, projectors, smart wearable devices (e.g., smart watches, smart glasses, head-mounted displays (HMDs), etc.), appliances, and Internet-of-Things (IoT) devices, among others. Consumed media can include, for example, live video content broadcast by a content server(s) to the client devices, pre-recorded video content available to the client devices on-demand, streaming video content, etc. In some instances, video content can be generated by one or more IoT devices, such as security cameras, and viewed by a user using one or more client devices.

In some cases, media content (video) streaming can be interrupted due to network conditions or other device malfunctions, such as due to network latency or jitter. In such instances, some video frames in the content stream may be dropped (e.g., due to packet loss) resulting in discontinuities in the stream, and a degraded user experience.

Aspects of the disclosed technology provide solutions for generating replacement frames to fill or replace dropped video frames. The replacement frames can fill or eliminate discontinuities, thereby improving the user's viewing experience in instances where network instabilities and/or device malfunctions may persist.

Replacement frames can be created using a generative machine-learning model, (or generative model) trained to create replacement frames (or replacement content) based on contextual information about or contained in the content of the video stream. For example, the generative model may be trained to generate replacement frames based on metadata relating to a video stream and/or based on the content of the frames, including but not limited to video data, audio data and/or event data relating to the video stream. By way of example, video and audio data corresponding with the dropped frames may provide information about the content of those frames that may be used by the generative model to generate replacement content (replacement frames). In a similar manner, video and audio data from non-dropped frames may also be used, including any video or audio corresponding with frames occur before and/or after the discontinuity.

Event data may include data describing (tagging) one or more events in a video stream. Event data, along with other types of metadata, may be provided as an input to the generative model, for example, to provide contextual information about behaviors occurring before and/or after an identified discontinuity. In some implementations, other types of metadata may also be provided, including but not limited to metadata regarding time of day, weather conditions, lighting conditions, etc. It is understood that various other types of metadata ma also be used, without departing from the scope of the disclosed technology. Such additional contextual information can be used to improve the accuracy of the generated replacement frames, e.g., so that the content of the replacement frames more precisely approximates events represented by the dropped frames e.g., in the stream discontinuity. Further details regarding various ways in which generative ML can be used to create replacement frames are provided below.

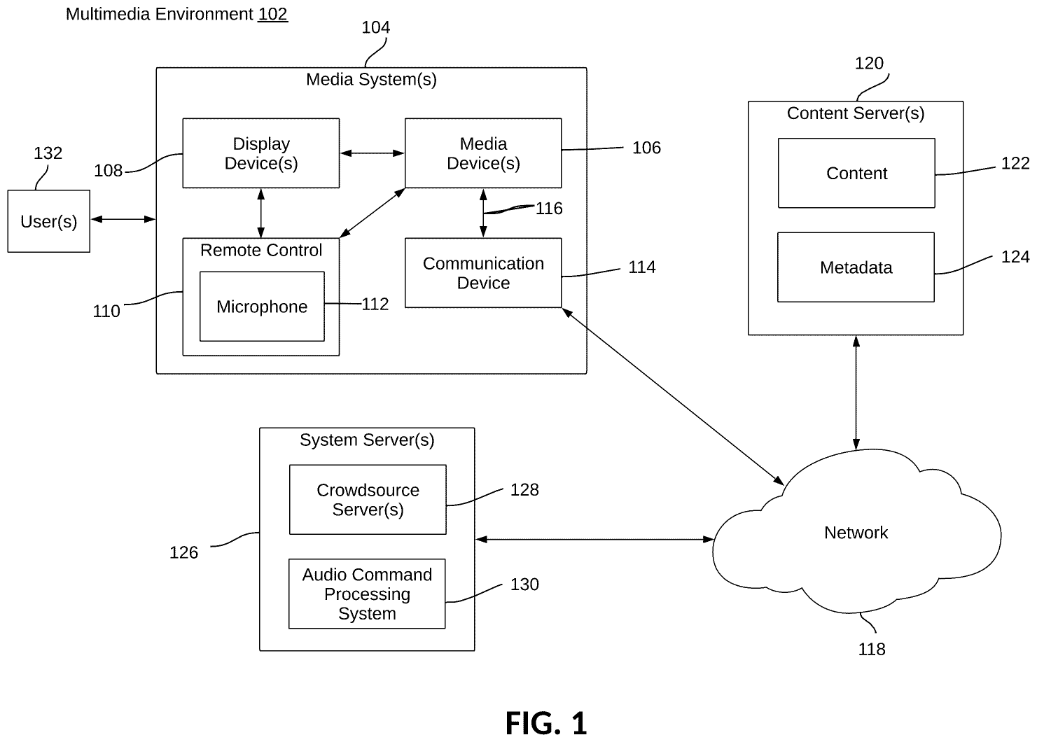

Various embodiments, examples, and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, television, tablet, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources). Although only one content server 120 is shown in FIG. 1, in practice, the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form. In some aspects, content 122 may include on-demand content, free ad-supported TV (FAST); advertising-based video on demand (AVOD); linear content, non-linear content, etc. In some cases, content 122 may be referred to herein as media content or media content item(s).

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index. In one illustrative example, metadata 124 may include one or more manifest files (e.g., XML files) that include metadata that is associated with a video stream such as, for instance, a dynamic adaptive streaming over HTTP (DASH) media stream or a HTTP live streaming (HLS) media stream.

In some examples, the content server 120 or the media device 106 can process content 122 and/or metadata 124 to identify portions of content 122 that include targeted media content. As used herein, targeted media content may include any type of media content (e.g., video content, image content, audio content, text content, etc.) that promotes or is otherwise associated with a product, service, brand, and/or event. In some configurations, content server 120 or media device 106 can identify targeted media content within content 122 based on metadata 124. For instance, metadata 124 can be used to derive one or more playback properties associated with content 122 such as playback duration; content server address(es) (e.g., uniform resource locator(s) URLs); closed-captioning content; encryption status; etc. In some cases, media device 106 or content sever 120 can use one or more of the playback properties (e.g., based on metadata 124) to identify portions of content 122 that correspond to targeted media content.

In some examples, the content server 120 or the media device 106 can process media content segments to extract features and information, such as contextual information, from the media content segments and classify the media content segments based on the extracted features and information. In some examples, the content server 120 or the media device 106 can determine and/or extract information (e.g., contextual information, content information and/or attributes, segment characteristics, etc.) about one or more segments of media content, and use the information to categorize the one or more segments of the media content. In some configurations, the content server 120 or the media device 106 can use the extracted information (e.g., contextual information) to classify portions of content 122 as targeted media content.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126. In some aspects, system servers 126 can store information associated with users 132 (e.g., user profile data, user preferences, historical data, etc.).

The media devices 106 may exist in thousands or millions of media systems 104. Accordingly, the media devices 106 may lend themselves to crowdsourcing embodiments and, thus, the system servers 126 may include one or more crowdsource servers 128. For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

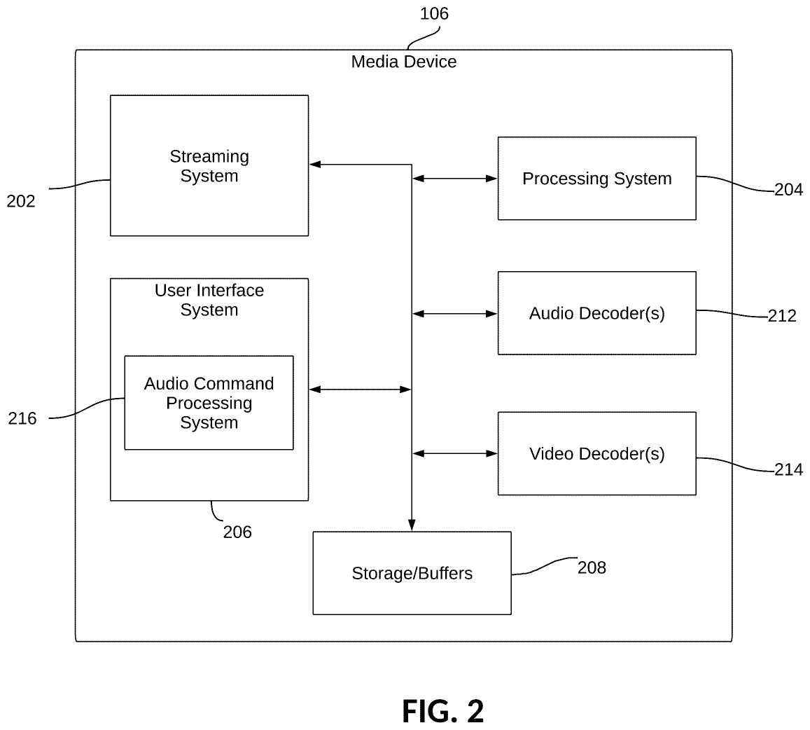

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some aspects of the present technology. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

Referring to FIG. 1, content server(s) 120, system servers 126, and/or media devices 106 can be configured to perform applicable functions related to customizing content 122. For example, users 132 can provide an input (e.g., via display devices 108, remote control 110, and/or media device(s) 106) indicative of a preferred level of exposure to targeted media content (e.g., video, audio, image, text, etc. that is associated with a product, service, brand, and/or event, such as a commercial). In some cases, content server(s) 120, system server(s) 126, and/or media devices 106 can implement one or more algorithms (e.g., heuristic-based algorithms, rule-based algorithms, machine learning models, etc.) that can be used process the user input and generate a customized targeted media content experience for the user. The customized targeted media content experience can include a customized amount of targeted media content, a customized frequency in presentation of targeted media content, a customized type of targeted media content, any other type of modification to the presentation of content 122, and/or any combination thereof.

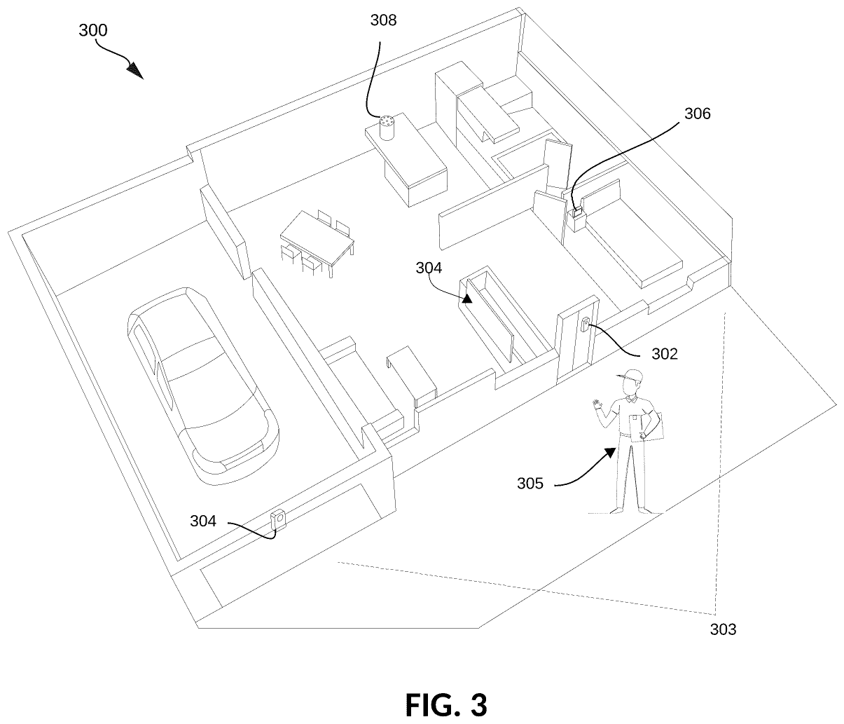

FIG. 3 illustrates an example system 300 that can be used to generate replacement frames for a media stream and to playback media content to a user. System 300 can include any number of processor-based devices, including but not limited to one or more cameras and/or media systems, such as media system 104, discussed above. As illustrated, system 300 includes cameras 302, 304, various media systems, including various playback devices (e.g., displays or TVs) 304, 306, and audio playback device 308. It is understood that a greater (or fewer) number of devices can be used, and that processing tasks, e.g., to generate replacement frames, may be performed by a single device, distributed amongst two or more devices in system 300, and/or performed by one or more remote systems (such as servers 126).

The devices of system 300 can be configured to communicate with various remote systems, such as content server 120 and/or system server 126, via one or more computer networks such as the Internet. In operation, the devices of system 300 can be used to receive and playback media content of different types, including video streams for entertainment content (e.g., movies, televisions shows, etc.), and/or to facilitate monitoring and surveillance of the surrounding environment. For example, cameras 302, 304 may be configured to monitor (record) events occurring within field of view 303, for example to provide a homeowner (user) with notifications or other alerts when specific events are detected. By way of example, a user of system 300 may be able to play recorded surveillance footage of events occurring within field-of-view 303 on any of playback devices 304, 306, 308.

As discussed above, playback of media content (e.g., surveillance footage, movies, TV shows, etc.) may be interrupted due to device and/or network malfunctions, such as increased latency or jitter resulting in the loss of video frames in a media stream. The resulting discontinuities can degrade the user's playback experience and it would therefore be helpful to generate replacement frames to fill these discontinuities. Aspects of the disclosed technology provide solutions for generating replacement frames that can be used to in place of the dropped frames, to provide a more continuous streaming experience to the user. In some implementations, the replacement frames can depict events that are indistinguishable from those events that would have been depicted in the dropped frames.

In some approaches, replacement frames can be created using a generative machine-learning approach, such as by using a Generative Adversarial Network (GAN), Variational Auto Encoders (VAE), and/or Diffusion-based models etc. It is understood that other types of generative ML models may be used, without departing from the scope of the disclosed technology.

### Media Playback Examples

By way of example, the devices of system 300 may be used to playback streaming media content, for example, that is received from a remote content server, such as content server 120. If device or network latency errors occur, the resulting packet loss may prevent all frames of a media stream from reaching the playback device, such as TV 304. In such cases, portions of the stream may be provided to a generative ML model and used to construct replacement data for the media stream, including replacement video frames and/or audio data, so that the stream discontinuities are unnoticed by the user. The replacement frames and/or audio data can be reconstructed from any information available about the media stream, including but not limited to metadata describing the stream, including but not limited to information about the content origin, title, type, episode, genre, score, and/or video and/or audio data collected by additional or other devices, for example, from different vantage points. and the like. Replacement frame construction can also be based on the content of the frames and audio information preceding or following the discontinuity or temporal location of the dropped frames.

In some approaches, discontinuities may be identified, for example, based on frame number metadata indicating an ordering of frames for a particular media stream. In such instances, gaps in the received frames, as identified from missing or incomplete frame numbering, can signify how many replacement frames need to be generated-or conversely, a length of replacement frame content needed to fill the discontinuity. In other approaches, discontinuities may be automatically identified through analysis of the content of one or more received frames, such as using one or more ML models trained for discontinuity detection, and/or using a machine vision approach.

Security System Examples In some implementations, one or more replacement frames may be generated to fill discontinuities in video streams originating from one or more devices in system 300, such as camera 302 and/or 304, which may be used for security monitoring purposes. In such instances, frame numbering metadata may be unavailable for use in identifying media stream discontinuities, and other types of metadata may be more salient. For example, cameras 304 and 304 can both be configured to identify and log events observed in their respective field-of-view, and in some instances to cross-reference or corroborate events jointly observed in overlapping field-of-view 303. Over time, each device 304, 304 may train a camera-specific ML model tuned to identify observed events at the premise of system 300. Such camera specific models can be used to perform event detection, identify discontinuities in video streams (e.g., due to network latency), and to generate replacement frames to fill identified continuities. Replacement frame generation can be based on event metadata, as well as frames captured before and/or after an identified discontinuity, video and/or audio data collected by additional or other devices, for example, from different vantage points. For example, if camera 302 observes an approach of visitor 305, but device/network issues result in the loss of subsequent frames, then event detection metadata (e.g., a metadata tag indicating “package delivery”) may be used to generate one or more replacement frames to fill the discontinuity, for example, by showing visitor 305 leaving a package and walking away.

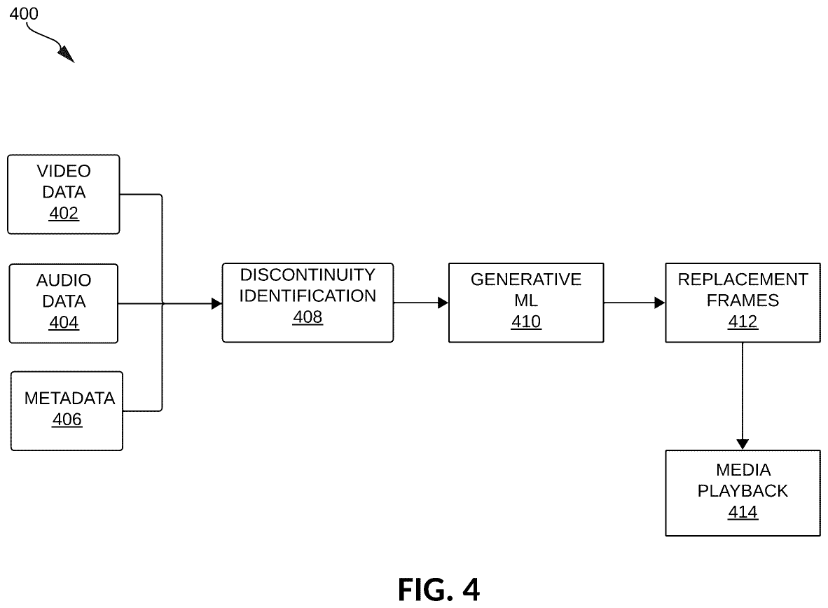

In some instances, data collected by one camera may be used to train and improve the generation of replacement frames for another device. For example, if camera 304 records an event, e.g., a package delivery by visitor 305, but the event is not entirely captured by camera 302, then the replacement frames generated to fill the discontinuity in the video stream from camera 302 may be based on one or more frames collected by camera 304. Further details regarding the generation of replacement frames, including the training of ML models for frame generation are discussed with respect to FIGS. 4-6, below.

FIG. 4 is a diagram illustrating an example system 400 that can be used to generate replacement frames. System 400 can be configured to receive different types of information about a given video (media) stream, including but not limited to video data 402, that includes image frames of the video stream, audio data 404 that can include audio information corresponding with video data 402, and metadata 406, that can include any information about the video data 402 and/or audio data 404. For example, metadata 406 may include event information for one or more events identified in video data 402, media content information (e.g., title, episode, frame numbering, etc.), and/or other types of information about the video stream. Video and/or audio data collected by additional or other devices, for example, from different vantage points can also be used as additional signals to generate replacement frames.

All or a portion of video data 402, audio data 404 and/or metadata 406 can then be used to identify one or more discontinuities in the media stream (block 408). For media streams that include entertainment content (e.g., movies, TV shows) frame index (or frame numbering) information may be available (in metadata 406) and used to identify discontinuities, e.g., by identifying which frames have not been received. In some instances, frame numbering information may also be available for other types of video streams, such as those coming from a security system (e.g., system 300) as discussed in relation to FIG. 3.

In other aspects, discontinuity identification 408 may be based on an analysis of video data 402 and/or audio data 404, for example, by using ML or computer-vision based approaches to determine where, and how many, frames have been dropped. In such cases, data for a media stream (including one or more of video data 402, audio data 404 and/or metadata 406) can be provided to an ML model that is trained to identify discontinuities. In other approaches, machine vision techniques may be used to identify object discontinuities, such as when a person represented in one frame jumps to an improbable location in the subsequent frame, suggesting that one or more intervening frames may be missing, i.e., a discontinuity. Audio data 404 may also be used to identify discontinuities, such as when there are interruptions or unexpected breaks. Identified discontinuities may be referenced using a frame number and/or a time stamp indicating an insertion point in the media stream/content where replacement frames are to be inserted.

Identified discontinuities (block 408) can be passed, along with video data 402, audio data 404 and/or metadata 406 to a generative ML model (block 410) and used to generate replacement frames (block 412). The replacement frames can then be added to the media content based on the temporal and/or numerical reference for a corresponding discontinuity. The replacement frames can therefore be used to fill the discontinuity and provide a completed media stream for playback by the user (block).

In some instances, creation of replacement frames (block 412) and or playback of generated replacement frames (414) may be restricted due to user privacy policies or settings. For example, users may have the ability to opt-out of having content generated that includes their likeness, including visual or audible reconstructions of how the user may look or sound. In some implementations such restrictions may be applied to devices owned or controlled by the user, and in other implementations the restrictions may apply more globally, such as to other devices that are not necessarily owned and/or controlled by the user.

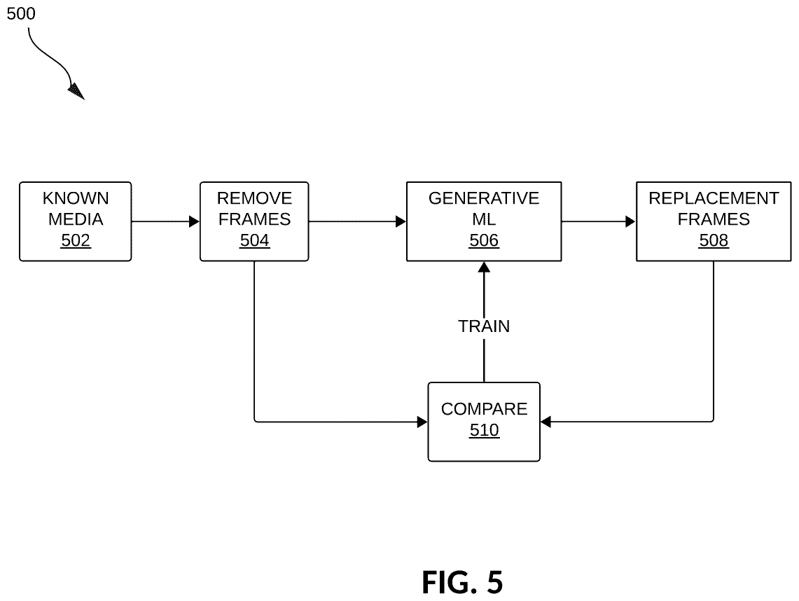

FIG. 5 is a diagram illustrating an example system 500 that can be used to train a generative ML model for replacement frame generation. Training of an ML model for use in generating replacement frames can be performed on a set of training data that includes known media content 502, such as media streams for which a complete set of video frame data and audio data exists. In some implementations portions of video and/or audio data may be removed from a media stream (block 504) and then the resulting media stream, which contains one or more discontinuities, can be provided to a generative ML model (block 506). The generative ML model can the produce replacement frames (block 508) based on the received content, and the replacement frames can be compared to the removed frames (block 510) to determine an accuracy of the generative ML model. That is, a loss function for feedback/training to the generative ML model can be based on a difference of the removed frames (known) and the replacement frames that are produced by the ML model (predicted).

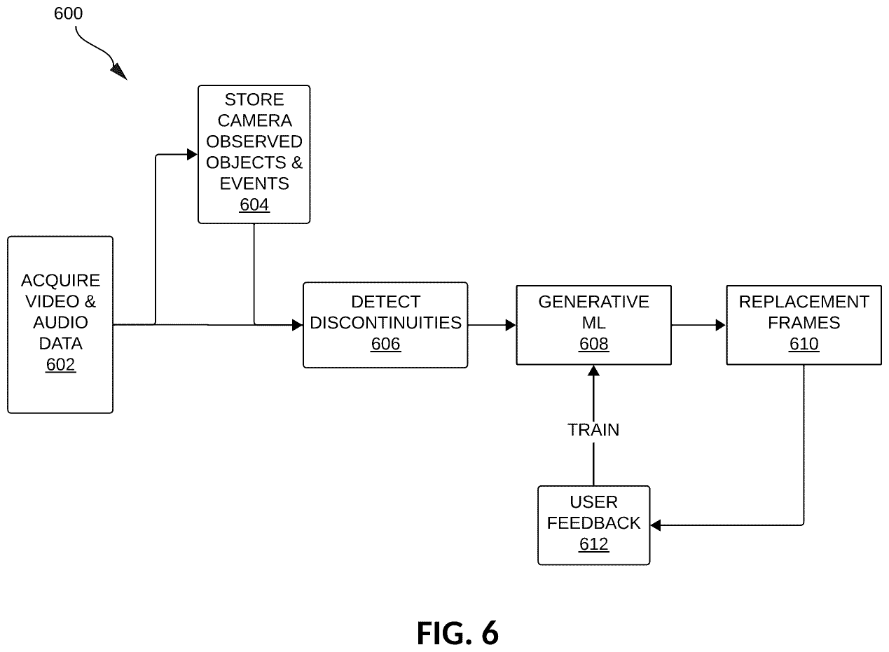

In some examples, the generative ML model may produce replacement frames (block 508) with the addition of other types of information, including but not limited to metadata describing the stream, audio information about the stream, and the like. It is understood that the generative ML model may also be configured to generate other types of data, such as audio data, that may be missing, using a similar training process. In some implementations, such as security system scenarios, model training may be performed with the benefit of other types of information, such as video and/or audio data collected by additional or other devices, for example, from different vantage points. Further details regarding ML training are described in further detail with respect to FIG. 6, below.

FIG. 6 is a diagram illustrating an example system 600 that can be used to train a generative ML model (e.g., generative ML model 608) for replacement frame generation using camera-specific ML models. Camera-specific models can be models trained or optimized for use with a specific device (camera), for example, that is deployed in a static or semi-static location. Camera-specific models can be trained (or optimized) for specific device specifications (e.g., camera resolution, frame capture rate, and/or image adjustment parameters, etc.) and/or characteristics and/or for features of a particular environment in which they are deployed, such as light levels, and field-of-view, etc. In some instances, camera-specific models can include ML models trained to perform object detection, including the recognition of inanimate objects (e.g., cars, packages, etc.), animate objects (e.g., pets, people) or specifically pre-identified behaviors (e.g., package delivery, visits by a neighbor or family member, arrival of caretakers or service providers, etc.).

Training of a given camera-specific model can begin with the acquisition of audio and/or video data for a given environment, such as by one or more of cameras 302, 304 in system 300, discussed above. Video and/or audio feeds for a specific device can be analyzed over time, for example to identify and store patterns of observed objects, events, and/or behaviors. For example, package delivery events can follow similar a similar pattern, with predictable sounds and/or observed objects (e.g., delivery personnel, packages, etc.) across multiple video frames, and lasting for predictable time durations. Over time, camera-specific models can become attuned to an associated environment and highly accurate at event identification as well as replacement frame generation the respective environment.

For newly received video streams, discontinuities can be detected (block 606), and passed to a generative ML model (block 608). In operation, the generative ML model 608 can use historic information about patterns (objects, events, behaviors) observed by a corresponding camera device, as well as information about identified discontinuities 606 to generate one or more replacement frames (block 610). By way of example, the replacement frames 610 may be used to represent animate and/or inanimate objects, as well as behaviors by the represented objects, based on the learned context in which the device (camera) is deployed. In some instances, user feedback may be used to determine if replacement frame outputs are accurate or acceptable to the user (e.g., a homeowner or operator of a security system), the user feedback can be used to further train/tune the generative ML model (block 612). As such, camera-specific models can improve accuracy of event identification, discontinuity identification and replacement frame generation over time, and with continued user feedback.

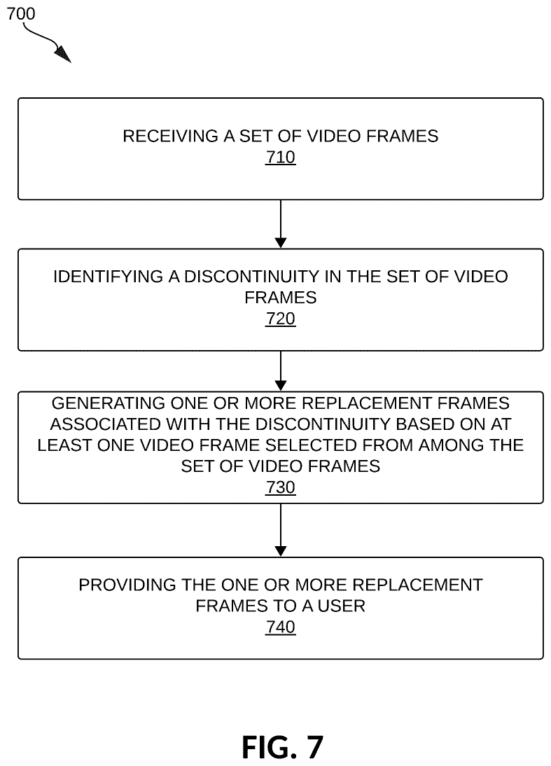

FIG. 7 is a diagram illustrating steps of a process 700 for generating replacement frames.

In step 710, process 700 includes receiving a set of vide frames. As discussed above, the video frames may be received as part of a video stream, such as during the receipt of media content from a remote content server (e.g., server 120). The received video frames may also be received from an image capture device, such as a camera that is deployed from monitoring in a home or business setting.

In step 720, process 700 includes identifying a discontinuity in the set of video frames. Discontinuities can result from dropped or corrupted frames in the set of received video frames. In some approaches, discontinuities can be identified based on video frame metadata, such as frame numbers. For example, non-consecutive frame numbering can indicate frames that have been lost/dropped, and used to determine a length of generated replacement content that is needed.

In step 730, process 700 includes generating one or more replacement frames associated with the discontinuity based on at least one video frame selected from among the set of video frames.

In step 740, process 700 includes providing one or more replacement frames to a user. As discussed above, user feedback may be used to further train a generative ML model, e.g., to improve the accuracy of generated frame content.

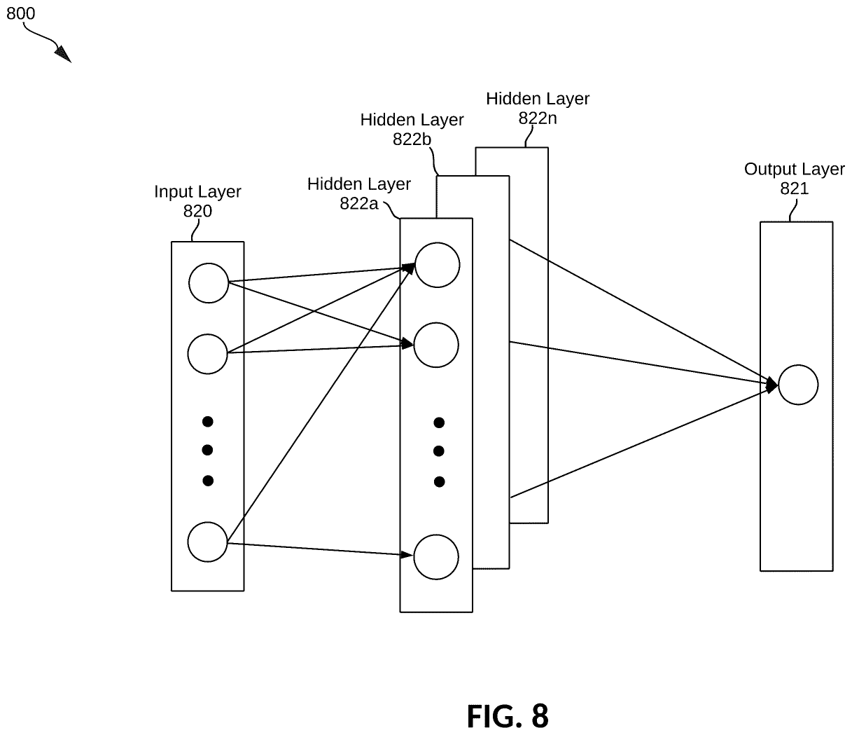

FIG. 8 is a diagram illustrating an example of a neural network architecture 800 that can be used to implement some or all of the neural networks described herein. The neural network architecture 800 can include an input layer 820 can be configured to receive and process data to generate one or more outputs. The neural network architecture 800 also includes hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The neural network architecture 800 further includes an output layer 821 that provides an output resulting from the processing performed by the hidden layers 822a, 822b, through 822n.

The neural network architecture 800 is a multi-layer neural network of interconnected nodes. Each node can represent a piece of information. Information associated with the nodes is shared among the different layers and each layer retains information as information is processed. In some cases, the neural network architecture 800 can include a feed-forward network, in which case there are no feedback connections where outputs of the network are fed back into itself. In some cases, the neural network architecture 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes in the neural network architecture 800 are shown as having multiple output lines, a node can have a single output and all lines shown as being output from a node represent the same output value.

In some cases, each node or interconnection between nodes can have a weight that is a set of parameters derived from the training of the neural network architecture 800. Once the neural network architecture 800 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 800 to be adaptive to inputs and able to learn as more and more data is processed.

The neural network architecture 800 is pre-trained to process the features from the data in the input layer 820 using the different hidden layers 822a, 822b, through 822n in order to provide the output through the output layer 821.

In some cases, the neural network architecture 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 800 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(1/2(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 800 can perform a backward pass by determining which inputs (weights) most contributed to the loss of the network, and can adjust the weights so that the loss decreases and is eventually minimized.

The neural network architecture 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 800 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

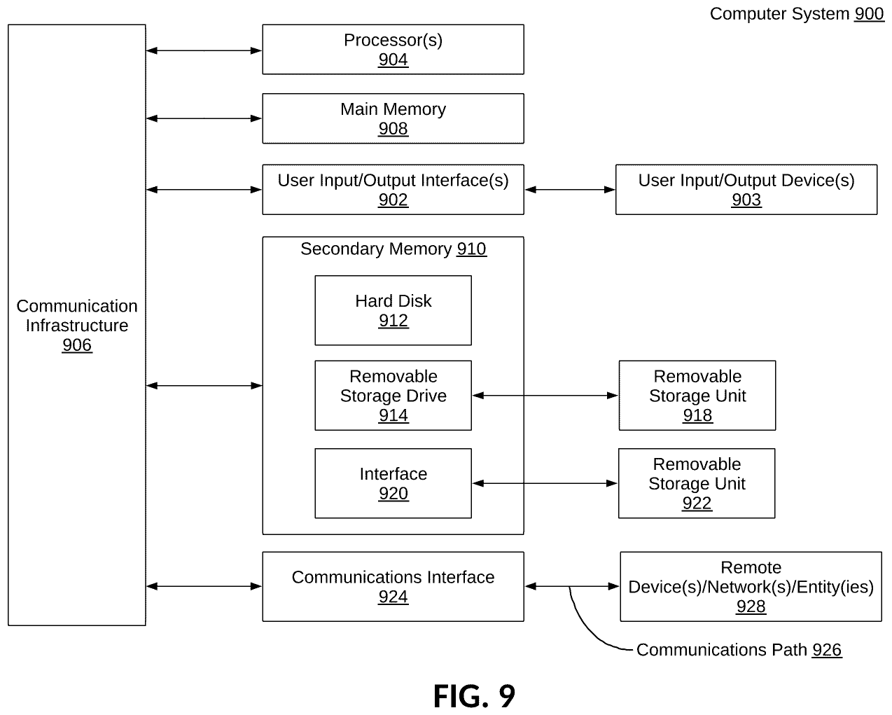

Various aspects and examples may be implemented, for example, using one or more well-known computer systems, such as computer system 900 shown in FIG. 9. For example, the media device 106 may be implemented using combinations or sub-combinations of computer system 900. Also or alternatively, one or more computer systems 900 may be used, for example, to implement any of the aspects and examples discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 900 may include a communication or network interface 924. Communication interface 924 may enable computer system 900 to communicate and interact with any combination of external devices, external networks, external entities, etc. (individually and collectively referenced by reference number 928). For example, communication interface 924 may allow computer system xx00 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900 or processor(s) 904), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. An apparatus comprising: at least one memory; and at least one processor coupled to the at least one memory, the at least one processor configured to: receive a set of video frames; identify a discontinuity in the set of video frames; generate one or more replacement frames associated with the discontinuity based on at least one video frame selected from among the set of video frames; and provide the one or more replacement frames to a user.
Aspect 2. The apparatus of Aspect 1, wherein to generate the one or more replacement frames, the at least one processor is configured to: provide at least one video frame selected from among the set of video frames to a generative machine-learning model; and receive the one or more replacement frames from the generative machine-learning model.
Aspect 3. The apparatus of Aspect 2, wherein the generative machine-learning model is trained using video frames collected by two or more imaging devices that have an overlapping field of view.
Aspect 4. The apparatus of any of Aspects 2 to 3, wherein the generative machine-learning model is camera-specific.
Aspect 5. The apparatus of any of Aspects 1 to 4, wherein to generate the one or more replacement frames, the at least one processor is configured to: provide audio data to a generative machine-learning model.
Aspect 6. The apparatus of any of Aspects 1 to 5, wherein to generate the one or more replacement frames, the at least one processor is configured to: provide event data to a generative machine-learning model, wherein the event data is associated with one or more events represented by the video frames.
Aspect 7. The apparatus of any of Aspects 1 to 6, wherein the at least one processor is further configured to: receive an input from the user, the input providing a quality indication for the one or more replacement frames.
Aspect 8. A computer-implemented method comprising: receiving a set of video frames; identifying a discontinuity in the set of video frames; generating one or more replacement frames associated with the discontinuity based on at least one video frame selected from among the set of video frames; and providing the one or more replacement frames to a user.
Aspect 9. The computer-implemented method of Aspect 8, further comprising: providing at least one video frame selected from among the set of video frames to a generative machine-learning model; and receiving the one or more replacement frames from the generative machine-learning model.
Aspect 10. The computer-implemented method of Aspect 9, wherein the generative machine-learning model is trained using video frames collected by two or more imaging devices that have an overlapping field of view.
Aspect 11. The computer-implemented method of any of Aspects 9 to 10, wherein the generative machine-learning model is camera-specific.
Aspect 12. The computer-implemented method of any of Aspects 8 to 11, wherein generating the one or more replacement frames further comprises providing audio data to a generative machine-learning model.
Aspect 13. The computer-implemented method of any of Aspects 8 to 12, wherein generating the one or more replacement frames further comprises providing event data to a generative machine-learning model, and wherein the event data is associated with one or more events represented by the video frames.
Aspect 14. The computer-implemented method of any of Aspects 8 to 13, further comprising: receiving an input from the user, the input providing a quality indication for the one or more replacement frames.
Aspect 15. A non-transitory computer-readable storage medium comprising at least one instruction for: receiving a set of video frames; identifying a discontinuity in the set of video frames; generating one or more replacement frames associated with the discontinuity based on at least one video frame selected from among the set of video frames; and providing the one or more replacement frames to a user.
Aspect 16. The non-transitory computer-readable storage medium of Aspect 15, wherein the at least one instruction is further configured for: providing at least one video frame selected from among the set of video frames to a generative machine-learning model; and receiving the one or more replacement frames from the generative machine-learning model.
Aspect 17. The non-transitory computer-readable storage medium of Aspect 16, wherein the generative machine-learning model is trained using video frames collected by two or more imaging devices that have an overlapping field of view.
Aspect 18. The non-transitory computer-readable storage medium of any of Aspects 16 to 17, wherein the generative machine-learning model is camera-specific.
Aspect 19. The non-transitory computer-readable storage medium of any of Aspects 15 to 18, wherein generating the one or more replacement frames further comprises providing audio data to a generative machine-learning model.
Aspect 20. The non-transitory computer-readable storage medium of any of Aspects 15 to 19, wherein generating the one or more replacement frames further comprises providing event data to a generative machine-learning model, and wherein the event data is associated with one or more events represented by the video frames.

1. An apparatus comprising:
at least one memory; and
at least one processor coupled to the at least one memory, the at least one processor configured to:
receive a set of video frames;
identify a discontinuity in the set of video frames;
generate one or more replacement frames associated with the discontinuity based on at least one video frame selected from among the set of video frames, wherein the one or more replacement frames are generated by a machine-learning model trained to create replacement frames based on contextual information, the contextual information including at least event data; and
provide the one or more replacement frames to a user.

2. The apparatus of claim 1, wherein to generate the one or more replacement frames, the at least one processor is configured to:
provide at least one video frame selected from among the set of video frames to a generative machine-learning model; and
receive the one or more replacement frames from the generative machine-learning model.

3. The apparatus of claim 2, wherein the generative machine-learning model is trained using video frames collected by two or more imaging devices that have an overlapping field of view.

4. The apparatus of claim 2, wherein the generative machine-learning model is camera-specific.

5. The apparatus of claim 1, wherein to generate the one or more replacement frames, the at least one processor is configured to:
provide audio data to a generative machine-learning model.

6. The apparatus of claim 1, wherein to generate the one or more replacement frames, the at least one processor is configured to:
the machine-learning model is trained by applying a loss function to compare predicted output values with target output values.

7. The apparatus of claim 1, wherein the at least one processor is further configured to:
receive an input from the user, the input providing a quality indication for the one or more replacement frames.

8. A computer-implemented method comprising:
receiving a set of video frames;
identifying a discontinuity in the set of video frames;
generating one or more replacement frames associated with the discontinuity based on at least one video frame selected from among the set of video frames, wherein the one or more replacement frames are generated by a machine-learning model trained to create replacement frames based on contextual information, the contextual information including at least event data; and
providing the one or more replacement frames to a user.

9. The computer-implemented method of claim 8, further comprising:
providing at least one video frame selected from among the set of video frames to a generative machine-learning model; and
receiving the one or more replacement frames from the generative machine-learning model.

10. The computer-implemented method of claim 9, wherein the generative machine-learning model is trained using video frames collected by two or more imaging devices that have an overlapping field of view.

11. The computer-implemented method of claim 9, wherein the generative machine-learning model is camera-specific.

12. The computer-implemented method of claim 8, wherein generating the one or more replacement frames further comprises providing audio data to a generative machine-learning model.

13. The computer-implemented method of claim 8, wherein the machine-learning model is trained by applying a loss function to compare predicted output values with target output values.

14. The computer-implemented method of claim 8, further comprising:
receiving an input from the user, the input providing a quality indication for the one or more replacement frames.

15. A non-transitory computer-readable storage medium comprising at least one instruction for:
receiving a set of video frames;
identifying a discontinuity in the set of video frames;
generating one or more replacement frames associated with the discontinuity based on at least one video frame selected from among the set of video frames, wherein the one or more replacement frames are generated by a machine-learning model trained to create replacement frames based on contextual information, the contextual information including at least event data; and
providing the one or more replacement frames to a user.

16. The non-transitory computer-readable storage medium of claim 15, wherein the at least one instruction is further configured for:
providing at least one video frame selected from among the set of video frames to a generative machine-learning model; and
receiving the one or more replacement frames from the generative machine-learning model.

17. The non-transitory computer-readable storage medium of claim 16, wherein the generative machine-learning model is trained using video frames collected by two or more imaging devices that have an overlapping field of view.

18. The non-transitory computer-readable storage medium of claim 16, wherein the generative machine-learning model is camera-specific.

19. The non-transitory computer-readable storage medium of claim 15, wherein generating the one or more replacement frames further comprises providing audio data to a generative machine-learning model.

20. The non-transitory computer-readable storage medium of claim 15, wherein the machine-learning model is trained by applying a loss function to compare predicted output values with target output values.
